(19) United States
(12) Patent Application Publication
(10) Pub. No.: US 2004/0088659 A1
(43) Pub. Date: May 6, 2004

(54) Semiconductor device having scan flip-flop and design method therefor

(76) Inventor: Junji Mori, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/325,740

(22) Filed: Dec. 23, 2002

(30) Foreign Application Priority Data
Oct. 30, 2002 (JP) 2002-316065

(51) Int. Cl. G06F 17/50

(52) U.S. Cl. 716/2; 716/4

(57) ABSTRACT

A semiconductor device having first and second operation modes includes a signal line, first and second flip-flops, and a switching circuit. The signal line transmits an instruction signal in the second operation mode. The first flip-flop operates in synchronism with a clock in the first operation mode and the instruction signal in the second operation mode. The switching circuit propagates an input to the output of the first flip-flop in response to the instruction signal in the second operation mode. The second flip-flop operates in synchronism with the clock in the first operation mode, and in the second operation mode, selects a test pattern as an input signal instead of an input signal in the first operation mode, and operates in synchronism with the clock.

### CROSS-REFERENCE TO RELATED APPLICATIONS

This application is based upon and claims the benefit of priority from the prior Japanese Patent Application No. 2002-316065, filed Oct. 30, 2002, the entire contents of which are incorporated herein by reference.

### BACKGROUND OF THE INVENTION

1. Field of the Invention

The present invention relates to a semiconductor integrated circuit and its design method and, more particularly, to a scan design method for a semiconductor integrated circuit.

2. Description of the Related Art

With recent increases in the scale of system LSIs (Large Scale Integrated Circuits), the number of flip-flops used for the design is increasing. At the same time, the number of pipelines in the design is also increasing with higher LSI operation frequencies.

The current design for testability exploits scan design. In scan design, F/Fs are connected in a serial chain to directly read out/write values held by the F/Fs. An LSI is divided into a plurality of combinational logic circuits, and a test pattern is automatically generated. In scan design, all F/Fs must be basically connected in a serial chain.

An example of the scan design method will be explained with reference to FIG. 1. FIG. 1 is a block diagram showing a flip-flop. In scan design, a D-flip-flop is given a function capable of selecting an input D and input SD, as shown in FIG. 1. The two inputs, i.e., the input D in a normal operation mode and the input SD in a scan operation mode are switched by a select signal S. The F/F (scan F/F) capable of selecting a serial chain input and a normal operation input enables a scan test.

The operation of the scan F/F is controlled by, e.g., a two-phase dedicated clock. The F/F can be externally controlled to prevent overlapping of two clocks when data is input/output using a serial chain. The method of controlling the operation by the two-phase clock is an effective means for preventing a data hold error caused by a clock skew. According to this method, switching between the input D and the input SD is controlled by the presence/absence of a clock. The influence of the scan F/F on the setup can be minimized, and this method is effective especially for designing an LSI which operates at a high frequency exceeding 1 GHz.

Along with recent larger LSI scales and higher operation frequencies, the area ratio of F/Fs to the whole circuit increases. An additional circuit necessary for scan design is large in scale. Scan design tends to increase the circuit scale of a semiconductor device. The additional circuit for scan design is used only in a test carried out immediately before a shipment of the semiconductor device (the test is to be referred to as shipping test hereinafter). In other words, in the conventional LSI, the area ratio of the circuit used for only the test of the LSI increases for a larger number of F/Fs.

As the number of scan F/Fs increases, the data input/output amount in the serial chain increases. The test time and test vector amount increase, and a tester which saves vectors requires a large-capacity memory, increasing the tester cost.

For higher operation frequencies, one conventional stage (between F/Fs) is divided into a plurality of stages by inserting F/Fs. A combinational logic circuit between F/Fs is divided into a plurality of combinational logic circuits to increase the operation speed. A control circuit on one stage performs simple operation, and a logic circuit between F/Fs may include only a buffer depending on the stage (particularly a data processing portion). In this case, the scan test merely confirms the wiring between F/Fs. The number of combinational logic circuits in which one scan F/F conducts a test decreases. In other words, the number of scan F/Fs increases wastefully.

To prevent this, a scan design method of forming only some of F/Fs of an LSI into scan F/Fs is proposed in “Toshinobu Ono et al., “An Application of Partial Scan Techniques to a High-End System LSI Design”, IEEE Proceedings of the Tenth Asian Test Symposium, November, 2001, p. 459”. Even this method cannot achieve a satisfactory effect.

### BRIEF SUMMARY OF THE INVENTION

A semiconductor device having first and second operation modes according to an aspect of the present invention comprises:

a signal line which transmits an instruction signal in the second operation mode;

a first flip-flop which operates in synchronism with a clock in the first operation mode and the instruction signal in the second operation mode;

a switching circuit which propagates an input to an output of the first flip-flop in response to the instruction signal in the second operation mode; and

a second flip-flop which operates in synchronism with the clock in the first operation mode, and in the second operation mode, selects a test pattern as an input signal instead of an input signal in the first operation mode, and operates in synchronism with the clock.

A semiconductor device design method according to an aspect of the present invention comprises:

designing a semiconductor integrated circuit while forming all flip-flops into bypass flip-flops;

performing an operation test of the semiconductor integrated circuit to determine whether a loop circuit incorporating the flip-flop exists; and

when the loop circuit is determined to exist, forming at least the flip-flop incorporated in the loop circuit into a scan flip-flop to change the loop circuit into a sequential logic circuit.

### BRIEF DESCRIPTION OF THE SEVERAL VIEWS OF THE DRAWING

FIG. 1 is a block diagram showing a conventional F/F and scan F/F;

FIG. 2 is a block diagram showing a semiconductor integrated circuit according to a first embodiment of the present invention;

FIG. 3 is a block diagram showing the arrangement of an F/F according to the first embodiment of the present invention;

FIG. 4A is a circuit diagram showing an arrangement of a scan F/F according to the first embodiment of the present invention;

FIG. 4B is a circuit diagram showing another arrangement of the scan F/F according to the first embodiment of the present invention;

FIG. 5A is a circuit diagram showing an arrangement of a bypass F/F according to the first embodiment of the present invention;

FIG. 5B is a circuit diagram showing another arrangement of the bypass F/F according to the first embodiment of the present invention;

FIG. 6 is a timing chart showing a clock, inverted clock, and control signal in the semiconductor integrated circuit according to the first embodiment of the present invention;

FIG. 7A is a block diagram showing the semiconductor integrated circuit in a shift operation state according to the first embodiment of the present invention;

FIG. 7B is a block diagram showing the semiconductor integrated circuit in a normal operation state according to the first embodiment of the present invention;

FIG. 7C is a block diagram showing the semiconductor integrated circuit in a shift operation state according to the first embodiment of the present invention;

FIG. 8A is a block diagram showing a semiconductor integrated circuit;

FIG. 8B is a block diagram showing the semiconductor integrated circuit according to the first embodiment of the present invention;

FIG. 9 is a block diagram showing a semiconductor integrated circuit according to a second embodiment of the present invention;

FIG. 10 is a circuit diagram showing an example of a sequential logic circuit;

FIG. 11 is a flow chart showing the flow of forming a scan F/F in the semiconductor integrated circuit according to the second embodiment of the present invention;

FIG. 12 is a block diagram showing a semiconductor integrated circuit according to a third embodiment of the present invention;

FIG. 13 is a circuit diagram showing an F/F;

FIG. 14 is a circuit diagram showing a scan F/F and bypass F/F according to the third embodiment of the present invention;

FIG. 15 is a timing chart showing an external clock, clock, and control signal in the semiconductor integrated circuit according to the third embodiment of the present invention;

FIG. 16 is a block diagram showing a semiconductor integrated circuit according to a fourth embodiment of the present invention;

FIG. 17A is a circuit diagram showing an arrangement of a scan F/F according to the fourth embodiment of the present invention;

FIG. 17B is a circuit diagram showing another arrangement of the scan F/F according to the fourth embodiment of the present invention;

FIG. 18 is a circuit diagram showing the arrangement of a bypass F/F according to the fourth embodiment of the present invention;

FIG. 19 is a timing chart showing a clock and control signal in the semiconductor integrated circuit according to the fourth embodiment of the present invention;

FIG. 20A is a circuit diagram showing the arrangement of the bypass F/F according to a first modification to the first embodiment of the present invention;

FIG. 20B is a circuit diagram showing the arrangement of the bypass F/F according to a second modification to the first embodiment of the present invention;

FIG. 20C is a circuit diagram showing the arrangement of the bypass F/F according to a third modification to the first embodiment of the present invention; and

FIG. 20D is a circuit diagram showing the arrangement of the bypass F/F according to a fourth modification to the first embodiment of the present invention.

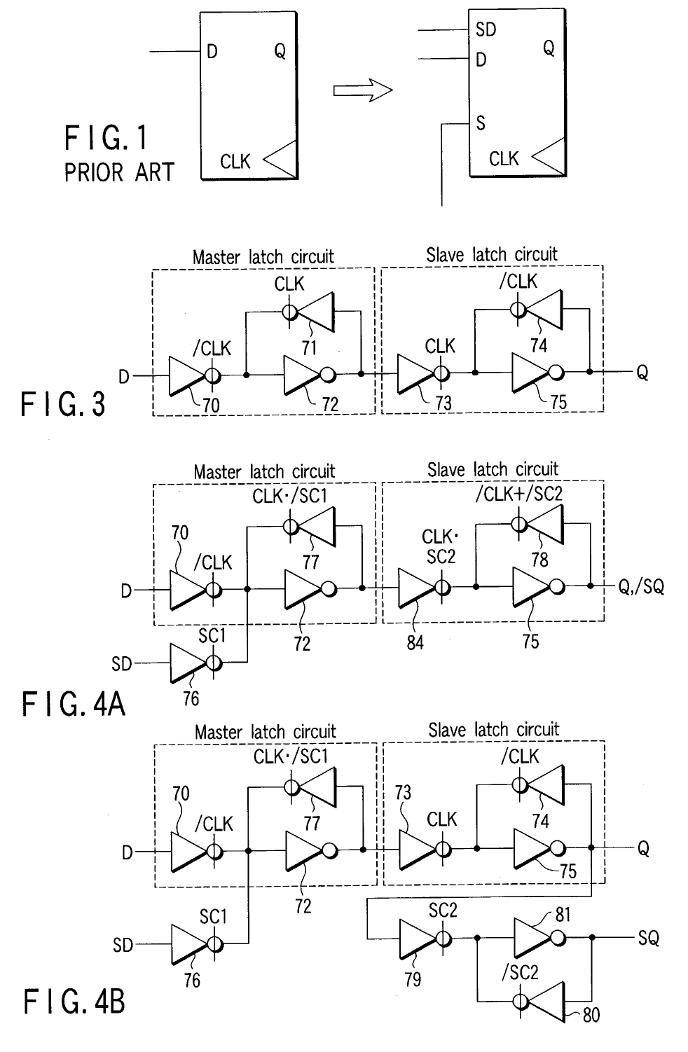

### DETAILED DESCRIPTION OF THE INVENTION

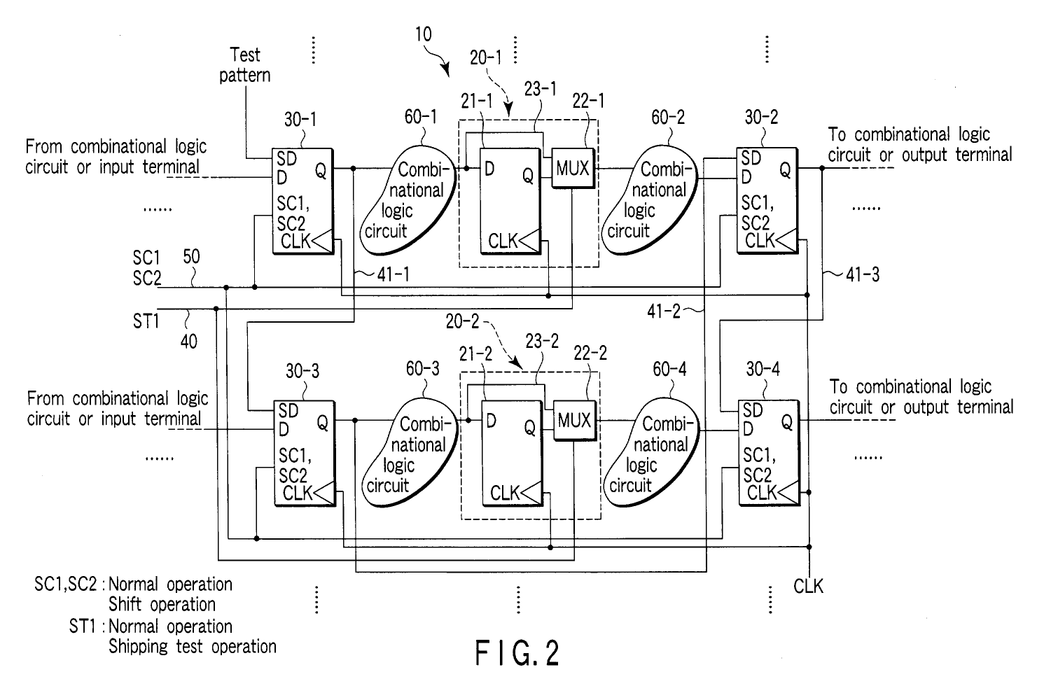

A semiconductor device according to the first embodiment of the present invention will be described with reference to FIG. 2. FIG. 2 is a block diagram showing the internal arrangement of a semiconductor integrated circuit (LSI).

As shown in FIG. 2, an LSI 10 comprises a plurality of bypass F/Fs 20-1, 20-2, etc. (first flip-flops), a plurality of scan F/Fs 30-1 to 30-4, etc., a first signal line 40, a second signal line 50, and combinational logic circuits 60-1 to 60-4, etc.

The bypass F/Fs 20-1, 20-2, etc. respectively comprise F/Fs 21-1, 21-2, etc. and multiplexers 22-1, 22-2, etc. (switching circuits). The input terminals D of the F/Fs 21-1 and 21-2 are respectively connected to the output terminals of the combinational logic circuits 60-1 and 60-3. Each of the multiplexers 22-1 and 22-2 selects either of signals from the input terminal D and output terminal Q of a corresponding one of the F/Fs 21-1 and 21-2 on the basis of a control signal ST1 (instruction signal) which propagates through the first signal line 40. The multiplexers 22-1 and 22-2 respectively output selected signals to the combinational logic circuits 60-2 and 60-4. By selecting signals from the input terminals D of the F/Fs 21-1 and 21-2 by the multiplexers 22-1 and 22-2, output signals from the combinational logic circuits 60-1 and 60-3 directly propagate to the combinational logic circuits 60-2 and 60-4 via signal lines 23-1 and 23-2 regardless of a clock CLK. The bypass F/Fs 20-1 and 20-2 have two operation modes: a normal operation mode; and shipping test operation mode. The multiplexers 22-1 and 22-2 select a signal from the output terminal Q in the normal operation mode (first operation mode) and a signal from the input terminal D in the shipping test operation mode (second operation mode).

The scan F/Fs 30-1 to 30-4 will be explained. The scan F/F 30-1 selects either of the input terminal D which receives data from a preceding combinational logic circuit or input terminal, and the input terminal SD which receives a test pattern. The scan F/F 30-1 receives a signal input to the selected input terminal. Selection operation is executed based on control signals SC1 and SC2 which propagate through the second signal line 50 and enter the scan F/F 30-1. The scan F/F 30-1 latches the selected signal and outputs it from the output terminal Q to the combinational logic circuit 60-1. The output terminal Q of the scan F/F 30-1 is also connected to the scan F/F 30-3 via a signal line 41-1 (serial chain).

The scan F/F 30-3 selects either of the input terminal D which receives data from a preceding combinational logic circuit or input terminal, and the input terminal SD which receives an output signal from the scan F/F 30-1 via the signal line 41-1. The scan F/F 30-3 receives a signal input to the selected input terminal. Selection operation is executed based on the control signals SC1 and SC2 which propagate through the second signal line 50 and enter the scan F/F 30-3. The scan F/F 30-3 latches the selected signal and outputs it from the output terminal Q to the succeeding combinational logic circuit 60-3. The output terminal Q of the scan F/F 30-3 is also connected to the scan F/F 30-2 via a signal line 41-2.

The scan F/F 30-2 selects either of the input terminal D which receives an output signal from the preceding combinational logic circuit 60-2, and the input terminal SD which receives an output signal from the scan F/F 30-3 via the signal line 41-2. The scan F/F 30-2 receives a signal input to the selected input terminal. Selection operation is executed based on the control signals SC1 and SC2 which propagate through the second signal line 50 and enter the scan F/F 30-2. The scan F/F 30-2 latches the selected signal and outputs it from the output terminal Q to the succeeding combinational logic circuit or output terminal. The output terminal Q of the scan F/F 30-2 is also connected to the scan F/F 30-4 via a signal line 41-3.

The scan F/F 30-4 selects either of the input terminal D which receives an output signal from the preceding combinational logic circuit 60-4, and the input terminal SD which receives an output signal from the scan F/F 30-2 via the signal line 41-3. The scan F/F 30-4 receives a signal input to the selected input terminal. Selection operation is executed based on the control signals SC1 and SC2 which propagate through the second signal line 50 and enter the scan F/F 30-4. The scan F/F 30-4 latches the selected signal and outputs it from the output terminal Q to the succeeding combinational logic circuit or output terminal.

Each of the scan F/Fs 30-1 to 30-4 has two operation modes: a normal operation mode and shift operation mode. Each of the scan F/Fs 30-1 to 30-4 selects a signal from the input terminal D in the normal operation mode and a test pattern input from the input terminal SD in the shift operation mode. The scan F/Fs 30-1 to 30-4 operate in accordance with the clock CLK.

The combinational logic circuits 60-1 to 60-4 respectively receive output signals from the scan F/F 30-1, bypass F/F 20-1, scan F/F 30-3, and bypass F/F 20-2, and perform logic operation. The combinational logic circuits 60-1 to 60-4 respectively output the operation results to the bypass F/F 20-1, scan F/F 30-2, bypass F/F 20-2, and scan F/F 30-4.

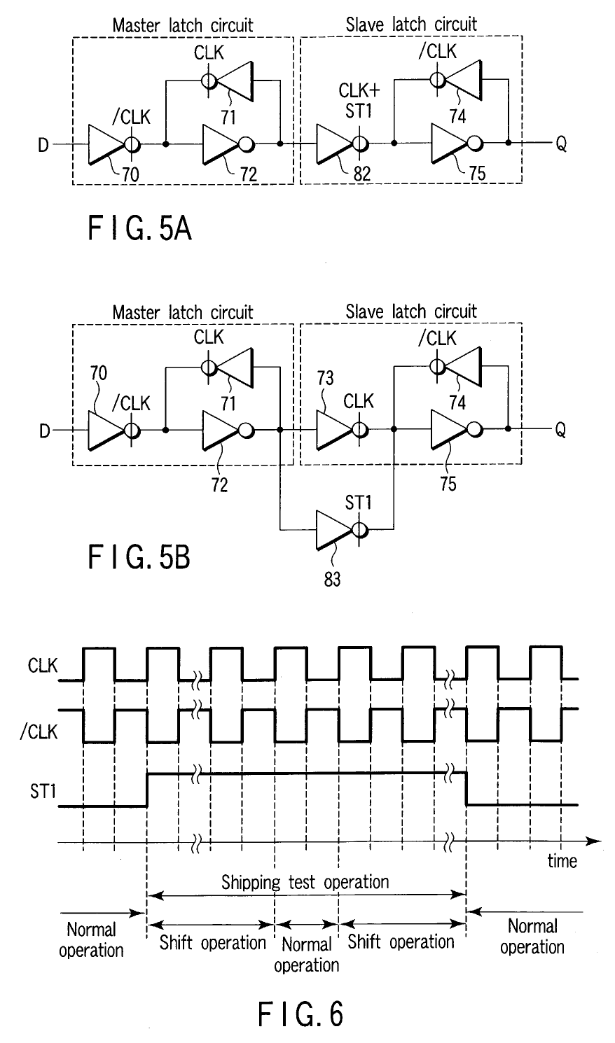

The detailed structures of the scan F/F and bypass F/F will be described with reference to FIGS. 3, 4A, 4B, 5A, and 5B. FIG. 3 is a circuit diagram showing a D-flip-flop before scan design or bypass design. FIGS. 4A and 4B are circuit diagrams showing the scan F/Fs 30-1 to 30-4. FIGS. 5A and 5B are circuit diagrams showing the bypass F/Fs 20-1 and 20-2.

The arrangement of the D-flip-flop before scan design or bypass design will be explained. As shown in FIG. 3, the D-flip-flop comprises a master latch circuit and slave latch circuit.

The master latch circuit has clocked inverters 70 and 71 and an inverter 72. The clocked inverter 70 functions as a transfer gate, and is opened (turned on) for a low-level clock CLK (inverted clock /CLK=high). For a high-level clock CLK (inverted clock /CLK=low level), the clocked inverter 70 stops operation. The clocked inverter 71 has an output terminal connected to the output terminal of the clocked inverter 70, and an input terminal connected to the output terminal of the inverter 72. The clocked inverter 71 is opened for a high-level clock CLK. The inverter 72 has an input terminal connected to the output terminal of the clocked inverter 70, and an output terminal serving as the output terminal of the master latch circuit.

The slave latch circuit has almost the same arrangement as that of the master latch circuit. More specifically, the slave latch circuit has clocked inverters 73 and 74 and an inverter 75. The clocked inverter 73 functions as a transfer gate, and is opened (turned on) for a high-level clock CLK (inverted clock /CLK=low). For a low-level clock CLK (inverted clock /CLK=high level), the clocked inverter 73 stops operation. The clocked inverter 74 has an output terminal connected to the output terminal of the clocked inverter 73, and an input terminal connected to the output terminal of the inverter 75. The clocked inverter 74 is opened for a low-level clock CLK. The inverter 75 has an input terminal connected to the output terminal of the clocked inverter 73, and an output terminal serving as the output terminal of the slave latch circuit, i.e., the output terminal Q of the F/F.

The arrangement of the scan F/Fs 30-1 to 30-4 will be explained with reference to FIG. 4A. FIG. 4A is a circuit diagram showing the scan F/Fs 30-1 to 30-4. The scan F/Fs 30-1 to 30-4 are obtained by giving the D-flip-flop shown in FIG. 3 a function of selecting either of the inputs D and SD.

As shown in FIG. 4A, each of the scan F/Fs 30-1 to 30-4 is formed by adding a clocked inverter 76 to the arrangement shown in FIG. 3, replacing the clocked inverter 71 with a clocked inverter 77, replacing the clocked inverter 73 with a clocked inverter 84, and replacing the clocked inverter 74 with a clocked inverter 78. The clocked inverter 76 has an input terminal connected to the input terminal SD, and an output terminal connected to the output terminal of the clocked inverter 70. The clocked inverter 76 is opened (turned on) for a high-level control signal SC1. The clocked inverter 77 is opened for a high-level AND signal between the clock CLK and an inverted control signal /SC. The clocked inverter 84 is opened for a high-level OR signal between the clock CLK and the control signal SC2. The clocked inverter 78 is opened for a high-level OR signal between the clock CLK and an inverted control signal /SC2.

FIG. 4B is a circuit diagram showing another arrangement of the scan F/Fs 30-1 to 30-4. As shown in FIG. 4B, each of the scan F/Fs 30-1 to 30-4 is formed by adding clocked inverters 76, 79, and 80 and an inverter 81 to the arrangement shown in FIG. 3, and replacing the clocked inverter 71 with the clocked inverter 77. The clocked inverter 76 has an input terminal connected to the input terminal SD, and an output terminal connected to the output terminal of the clocked inverter 70. The clocked inverter 76 is opened for a high-level control signal SC1. The clocked inverter 79 has an input terminal connected to the output terminal Q of the slave latch circuit, and is opened for a high-level control signal SC2. The clocked inverter 80 has an output terminal connected to the output terminal of the clocked inverter 79, and is opened for a high-level inverted control signal /SC2 (control signal SC2=low). The inverter 81 has an input terminal connected to the output terminal of the clocked inverter 79, and an output terminal connected to the input terminal of the clocked inverter 80. When the input terminal SD is selected, the output terminal of the inverter 81 acts as the output terminal SQ of the scan F/F.

The arrangement of the bypass F/Fs 20-1 and 20-2 will be described with reference to FIG. 5A. FIG. 5A is a circuit diagram showing the bypass F/F. The bypass F/F can bypass the input and output in the D-flip-flop shown in FIG. 3.

As shown in FIG. 5A, each of the bypass F/Fs 20-1 and 20-2 is formed by replacing the clocked inverter 73 in the D-flip-flop shown in FIG. 3 with a clocked inverter 82. The clocked inverter 82 is opened for a high-level OR signal between the clock CLK and a control signal ST1. That is, the clocked inverter 82 is opened when either of the clock CLK and control signal ST1 is at high level.

FIG. 5B is a circuit diagram showing another arrangement of the bypass F/Fs 20-1 and 20-2. As shown in FIG. 5B, each of the bypass F/Fs 20-1 and 20-2 is formed by adding a clocked inverter 83 to the D-flip-flop shown in FIG. 3. The clocked inverter 83 has an input terminal connected to the output terminal of the inverter 72, and an output terminal connected to the input terminal of the inverter 75. The clocked inverter 83 is opened for a high-level control signal ST1.

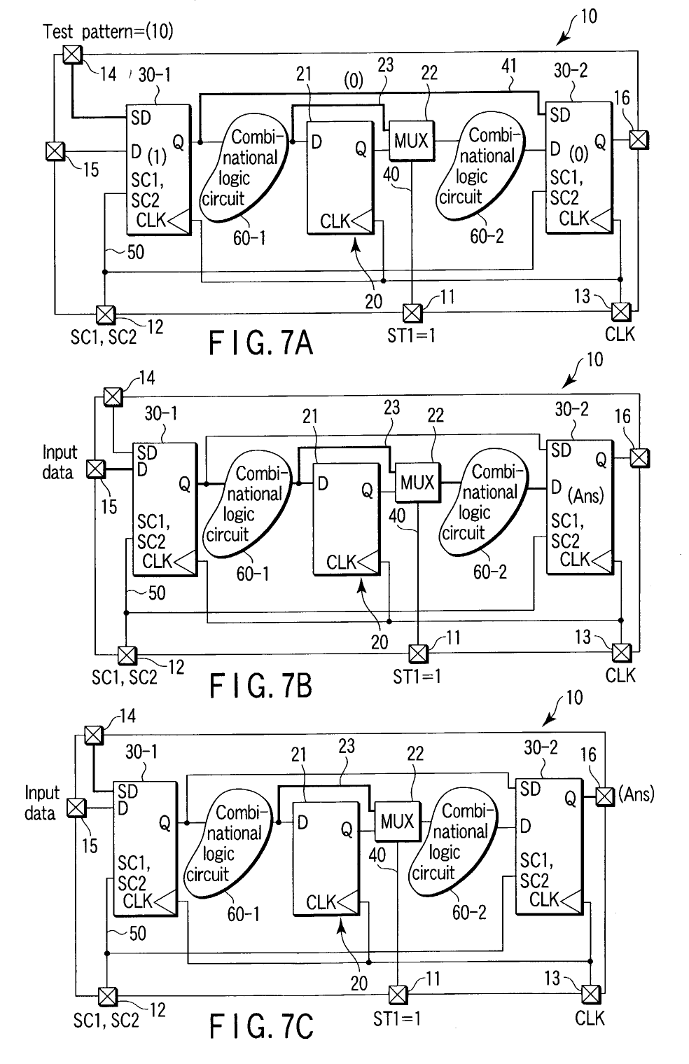

A semiconductor device scan test method according to the first embodiment will be described with reference to FIGS. 6 to 7C. FIG. 6 is a timing chart showing the clock CLK, inverted clock /CLK, and control signal ST1. FIGS. 7A to 7C are block diagrams of a semiconductor integrated circuit, and show the arrangement of FIG. 2 simplified for descriptive convenience. Since the operation of the scan F/F is the same as the conventional one, attention is given to the operation of the bypass F/F.

As shown in FIGS. 7A to 7C, the LSI 10 comprises the bypass F/F 20, scan F/Fs 30-1 and 30-2, combinational logic circuits 60-1 and 60-2, first signal line 40, and second signal line 50. For example, a scan test starts at time t1.

At the start of the scan test, the control signal ST1 input from an input pin 11 of the semiconductor integrated circuit 10 changes to “1”. The bypass F/F 20 then shifts from the normal operation mode to the shipping test operation mode. The scan F/Fs 30-1 and 30-2 shift from the normal operation mode to the shift operation mode. This state is illustrated in FIG. 7A. FIG. 7A is a block diagram showing the semiconductor integrated circuit.

The scan F/F 30-1 selects an input from the input terminal SD to receive a test pattern input from an input pin 14. Assume that the test pattern is “10”. The scan F/F 30-1 receives “1” in response to input of the clock CLK. The scan F/F 30-2 connected in a serial chain to the scan F/F 30-1 receives “0” via the signal line 41. In the shift operation mode, respective bits of the test pattern are sequentially shifted to the scan F/Fs, and the scan F/Fs connected in a serial chain receive the respective bits of the test pattern. The bypass F/F 20 not connected in a serial chain to the scan F/Fs 30-1 and 30-2 does not receive any test pattern. Because of the control signal ST1=1, the bypass F/F 20 changes to a state where it so operates as to output an internally stored signal to the output terminal regardless of the clock CLK. This state will be explained with reference to FIG. 5A. In FIG. 5A, the clocked inverter 82 operates in response to the AND signal between the clock CLK and ST1. In the shipping test operation mode, the control signal ST1 is always “1”, and the clocked inverter 83 is always open. In the arrangement of FIG. 5B, the clocked inverter 83 is always open. Input data is therefore output from the output terminal D regardless of the presence/absence of the clock. In other words, the bypass F/F can be regarded as a signal line which connects the combinational logic circuits 60-1 and 60-2, or a buffer circuit.

At time t2 when all the scan F/Fs 30-1 and 30-2 store the test pattern, the scan F/Fs 30-1 and 30-2 shift to the normal operation mode. Data is input from an input pin 15 of the semiconductor integrated circuit 10. This state is shown in FIG. 7B. One clock CLK is input after shift to the normal operation mode, and “1” stored in the scan F/F 30-1 is input to the input terminal of the combinational logic circuit 60-1. The combinational logic circuit 60-1 executes logic operation based on the input data “1”. The input signal of the bypass F/F 20 is bypassed to an output terminal. Hence, the logic operation result of the combinational logic circuit 60-1 is input to the combinational logic circuit 60-2. The combinational logic circuit 60-2 performs logic operation based on the operation result of the combinational logic circuit 60-1. The scan F/F 30-2 in the normal operation mode receives an input signal from the input terminal D. Thus, the operation result “Ans” of the combinational logic circuit 60-2 is input to the scan F/F 30-2.

At time t3 one clock CLK after time t2, the scan F/Fs 30-1 and 30-2 shift to shift operation again. This state is illustrated in FIG. 7C. FIG. 7C is a block diagram showing the semiconductor integrated circuit. Data stored in the scan F/Fs 30-1 and 30-2 connected in a serial chain are shifted. The operation result “Ans” stored in the scan F/F 30-2 is extracted from an output pin 16 of the semiconductor integrated circuit.

Whether the combinational logic circuits 60-1 and 60-2 operate normally, i.e., whether an error occurs can be determined depending on whether the obtained operation result “Ans” coincides with an expected value.

At time t4, the bypass F/F 20 and the scan F/Fs 30-1 and 30-2 shift to the normal operation mode. The bypass F/F 20 in the normal operation mode performs the same operation as that of a general F/F. In the normal operation mode, the control signal ST1 is fixed to “0”. In FIG. 5B, the clocked inverter 83 is always closed. In FIG. 5A, the clocked inverter 82 operates in response to the clock CLK.

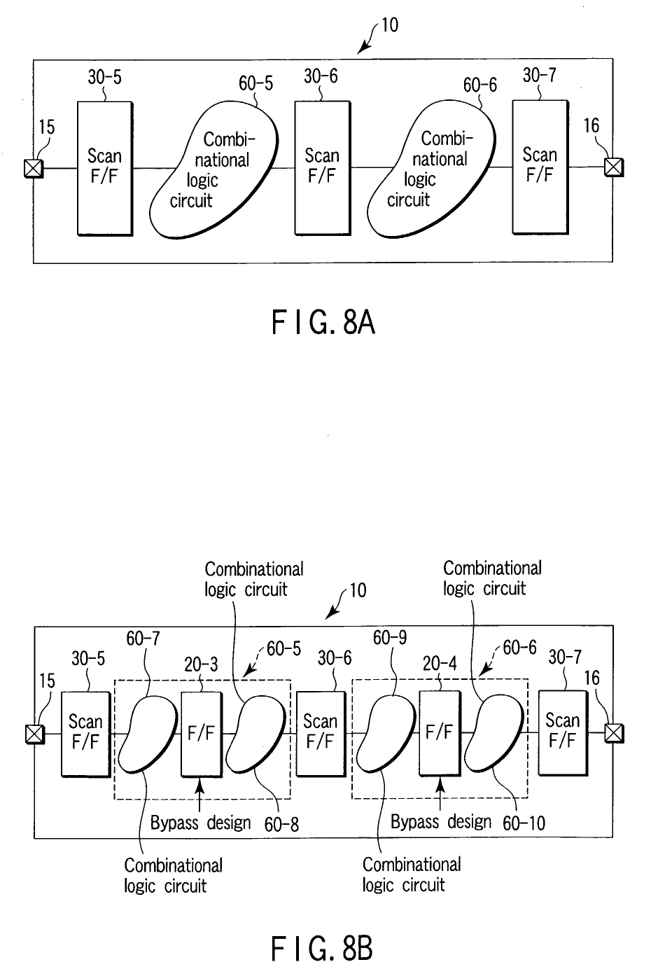

As described above, in the semiconductor device according to the first embodiment, the number of scan F/Fs can be greatly decreased to reduce the circuit area without decreasing the fault coverage. This will be explained with reference to FIGS. 8A and 8B. FIGS. 8A and 8B are block diagrams showing a semiconductor integrated circuit.

Assume that the semiconductor integrated circuit includes three F/Fs 30-5 to 30-7 and two combinational logic circuits 60-5 and 60-6 each interposed between two F/Fs, as shown in FIG. 8A. For scan design, all the three F/Fs are formed into scan F/Fs.

As described in the prior art, recent semiconductor integrated circuits require higher operation speeds. To meet the demand for higher operation speeds, the processing time in each combinational logic circuit must be shortened. In other words, the combinational logic circuit must be simplified. FIG. 8B shows a circuit example of simplifying the combinational logic circuit by adding an F/F.

As shown in FIG. 8B, F/Fs 20-3 and 20-4 are added to the arrangement shown in FIG. 8A to divide the combinational logic circuits 60-5 and 60-6 into two combinational logic circuits 60-7 and 60-8 and two combinational logic circuits 60-9 and 60-10, respectively. In the conventional method, the added F/Fs 20-3 and 20-4 are also formed into scan F/Fs. This increases the number of scan F/Fs and the circuit area.

In the arrangement according to the first embodiment, the two newly added F/Fs 20-3 and 20-4 are formed not into scan F/Fs but bypass F/Fs. That is, in the scan test, data passes through the F/Fs 20-3 and 20-4. In other words, the semiconductor circuits 60-5 and 60-6 function as sequential logic circuits in the normal operation mode and combinational logic circuits in the test operation mode. The functions are switched by the bypass F/Fs 20-3 and 20-4. Each of the bypass F/Fs 20-3 and 20-4 operates as a general F/F in the normal operation mode, and propagates an input signal to the next stage in response to the clock. The semiconductor circuits 60-5 and 60-6 operate as sequential logic circuits. In the test operation mode, each of the bypass F/Fs 20-3 and 20-4 propagates an input signal to the next stage in response to the control signal ST1 regardless of the clock. The semiconductor circuits 60-5 and 60-6 function as combinational logic circuits. Referring to FIG. 2, a semiconductor circuit made up of the combinational logic circuits 60-1 and 60-2 and the bypass F/F 20-1 functions as a combinational logic circuit or sequential logic circuit in response to the operation mode of the bypass F/F 20-1. More specifically, the semiconductor circuit functions as a sequential logic circuit when the bypass F/F 20-1 is in the normal operation mode, the semiconductor circuit functions as a combinational logic circuit when the bypass F/F 20-1 is in the shipping test operation mode. An additional circuit necessary for bypass design is the same as that for scan design at the gate level, as shown in FIG. 2. As described above with reference to FIGS. 4A to 5B, an actual circuit arrangement becomes smaller in scale that for scan design, suppressing an increase in circuit area.

The arrangement of the combinational logic circuit is simplified by increasing the number of F/Fs in order to attain a high operation speed of the semiconductor integrated circuit. In recent semiconductor integrated circuits, the arrangement of one combinational logic circuit, i.e., the combinational logic circuit 60-5 or 60-6 in FIG. 8A is satisfactorily simplified, as described in the prior art. With a high-performance ATPG (Auto Test Pattern Generation) tool which generates a test pattern, the fault coverage is hardly influenced at all by formation of the F/Fs 20-3 and 20-4 added to increase the operation speed into scan F/Fs. In other words, the fault coverage is the same between the arrangements of FIGS. 8A and 8B. By forming an added F/F not into a scan F/F but a bypass F/F, maintenance of the fault coverage and suppression of an increase in circuit area can be achieved while increasing the operation speed of the semiconductor integrated circuit.

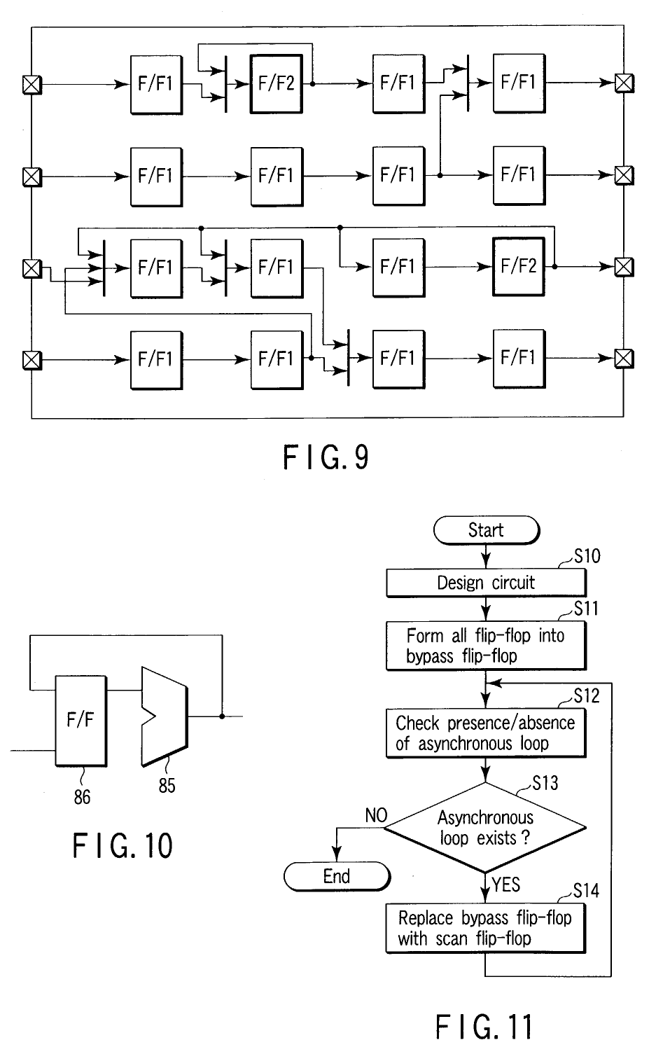

A semiconductor device and its design method according to the second embodiment of the present invention will be described with reference to FIG. 9. FIG. 9 is a block diagram showing the internal arrangement of a semiconductor integrated circuit. The second embodiment concerns another approach for realizing the scan design method described in the first embodiment.

As shown in FIG. 9, an LSI 10 comprises a plurality of bypass F/Fs 1, a plurality of scan F/Fs 2, and a combinational logic circuit (not shown). In the arrangement according to the second embodiment, only F/Fs included in a circuit having a loop are formed into scan F/Fs. This will be explained with reference to FIG. 10. FIG. 10 shows an example of the circuit having a loop.

As shown in FIG. 10, the output terminal of an adder 85 is connected to its input terminal via an F/F 86. Such a sequential logic circuit is widely applied to a circuit which increments the value one by one. The output from the adder 85 increases every clock CLK input to the F/F. For this reason, the F/F in the loop circuit cannot be formed into a bypass F/F. Forming a bypass F/F in the sequential logic circuit equals changing a sequential logic circuit into a combinational logic circuit. The presence of the loop in the combinational logic circuit prevents the value of an output signal from being a predetermined value. In the example of FIG. 10, an output from the adder 85 returns to the input regardless of the clock, and the output from the adder 85 does not settle on a predetermined value. Accordingly, the F/F in the loop circuit cannot be formed into a bypass F/F.

Considering this, a scan design method for a semiconductor device according to the second embodiment will be explained with reference to FIG. 11. FIG. 11 is a flow chart showing the semiconductor device design method.

A semiconductor integrated circuit is designed (step S10), and all F/Fs included in it are formed into bypass F/Fs (step S11). That is, all F/Fs in FIG. 9 are formed into bypass F/Fs having the arrangement shown in FIG. 5A or 5B described in the first embodiment, thus forming one combinational logic circuit.

The presence/absence of an asynchronous loop is checked (step S12). This means that whether a loop exists in the combinational logic circuit is checked. Since the F/Fs are formed into bypass F/Fs at this time, the circuit including the F/Fs operates as a combinational logic circuit at this time. In this step, ATPG is executed in the semiconductor integrated circuit shown in FIG. 9 that is designed using bypass F/Fs. First, only input and output pins are set as control and observation points. Then, the control signal ST1 is set to “1”, and all the bypass F/Fs shift to the shipping test operation mode (bypass state). In this state, a test pattern is input to conduct a test. In the presence of a loop in which an output from a given combinational logic circuit returns to its input, this loop is recognized as an asynchronous loop in the ATPG. A warning is generated in the ATPG to output a message so as to divide the loop (step S13).

An F/F to which the message has been output is formed into a scan F/F. That is, the bypass F/F is replaced with a scan F/F having the arrangement shown in FIG. 4A or 4B in the first embodiment (step S14). If no message is output, no bypass F/F need be replaced with a scan F/F.

In the design of the semiconductor integrated circuit, scan and bypass F/Fs are optimally selected.

With the use of bypass F/Fs, the semiconductor device and its design method according to the second embodiment can obtain the same effects as those of the first embodiment. Indiscriminate formation of a bypass F/F may generate a combinational logic circuit having a loop. However, in the arrangement and method according to the second embodiment, a loop is searched for, and only an F/F in the circuit having the loop is formed into a scan F/F. This can improve the operation reliability of the semiconductor integrated circuit and minimize the number of scan F/Fs. Compared to the first embodiment, the second embodiment can suppress an increase in circuit area.

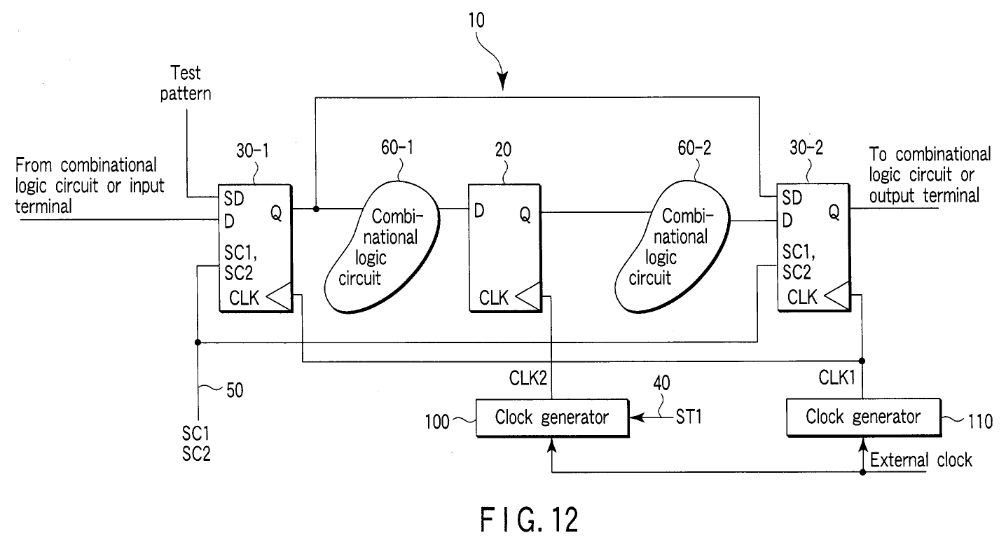

A semiconductor device according to the third embodiment of the present invention will be described with reference to FIG. 12. FIG. 12 is a block diagram showing a semiconductor integrated circuit. The semiconductor integrated circuit according to this embodiment also comprises many F/Fs and combinational logic circuits, as described in the first embodiment with reference to FIG. 2. For descriptive convenience, a simplified circuit arrangement is shown.

As shown in FIG. 12, an LSI 10 has a bypass F/F 20, scan F/Fs 30-1 and 30-2, a first signal line 40, a second signal line 50, combinational logic circuits 60-1 and 60-2, and clock generators (switching circuits) 100 and 110.

The clock generator 110 generates a clock CLK1 on the basis of an external clock. The clock generator 100 generates a clock CLK2 on the basis of the external clock and the control signal ST1 which propagates through the first signal line 40. While the control signal ST1 is “0”, the clock generator 100 generates the clock CLK2 identical to the clock CLK1. The clocks CLK1 and CLK2 will be described later.

The input terminal D of the bypass F/F 20 is connected to the output terminal of the combinational logic circuit 60-1. The output terminal Q is connected to the input terminal of the combinational logic circuit 60-2. The bypass F/F 20 operates in response to the clock CLK2. The bypass F/F 20 has two operation modes: a normal operation mode and shipping test operation mode, similar to the first embodiment. In the shipping test operation mode, the bypass F/F 20 directly propagates a signal from the input terminal D to the output terminal Q.

The scan F/Fs 30-1 and 30-2 have the same arrangement as that of the first embodiment, and operate in response to the clock CLK1.

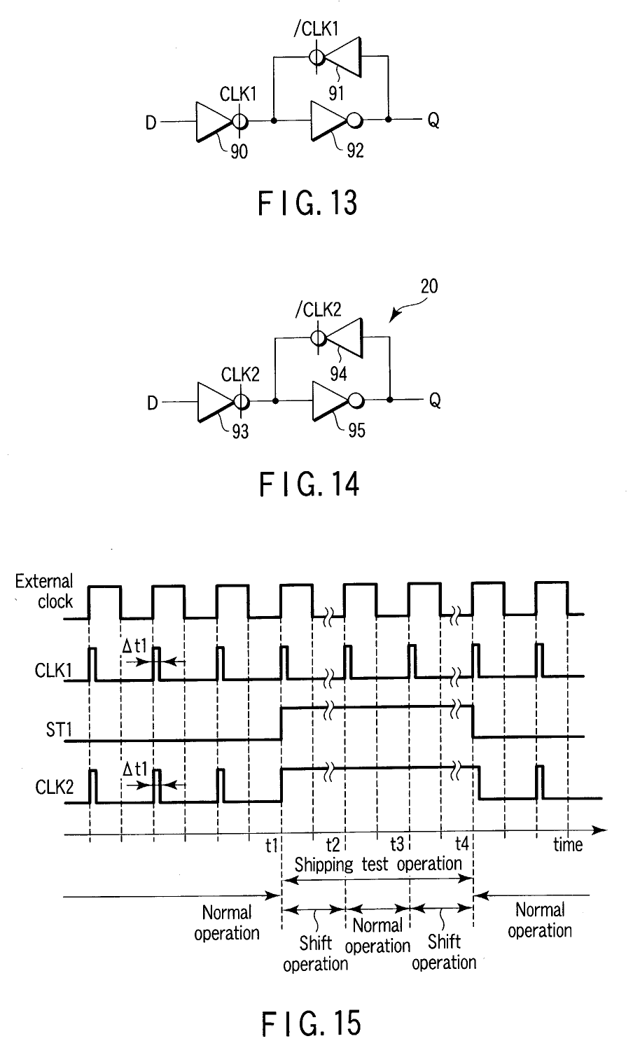

The detailed arrangement of the bypass F/F according to the third embodiment will be described with reference to FIGS. 13 and 14. FIG. 13 is a circuit diagram showing an example of a D-flip-flop having an arrangement different from that of FIG. 3 before the F/F is formed into a bypass F/F. FIG. 14 is a circuit diagram showing the bypass F/F 20.

As shown in FIG. 13, the D-flip-flop comprises clocked inverters 90 and 91 and an inverter 92. The clocked inverter 90 functions as a transfer gate, and is opened for a high-level clock CLK1. The clocked inverter 91 has an output terminal connected to the output terminal of the clocked inverter 90, and an input terminal connected to the output terminal of the inverter 92. The clocked inverter 91 is opened for a low-level clock CLK1. The inverter 92 has an input terminal connected to the output terminal of the clocked inverter 90, and an output terminal serving as the output terminal of the F/F.

The bypass F/F 20 comprises clocked inverters 93 and 94 and an inverter 95. The clocked inverter 93 functions as a transfer gate, and is opened for a high-level clock CLK2. The clocked inverter 94 has an output terminal connected to the output terminal of the clocked inverter 93, and an input terminal connected to the output terminal of the inverter 95. The clocked inverter 94 is opened for a low-level clock CLK2. The inverter 95 has an input terminal connected to the output terminal of the clocked inverter 93, and an output terminal serving as the output terminal of the bypass F/F.

Although not shown, the scan F/F according to the third embodiment is formed to be able to select either the input D or SD in the arrangement shown in FIG. 3.

A semiconductor device scan test method according to the third embodiment will be described with reference to FIGS. 12 and 15. FIG. 15 is a timing chart showing the external clock, clocks CLK1 and CLK2, and control signal ST1.

The relationship between the four signals will be explained. When an external clock is input, the clock generator 110 generates a clock CLK1 which changes to high level by only Δt1 from the rise of the external clock. The clock CLK1 has a shape in which the pulse rises instantaneously. When the control signal ST1 is “0”, the clock generator 100 generates a clock CLK2 with the same shape as that of CLK1. When the control signal ST1 is “1”, the clock CLK2 is fixed to high level.

As shown in FIG. 15, a scan test starts at time t1. At the start of the scan test, the control signal ST1 input from an input pin is set to “1”. The bypass F/F 20 then shifts from the normal operation mode to the shipping test operation mode. The scan F/Fs 30-1 and 30-2 shift from the normal operation mode to the shift operation mode. The scan F/F 30-1 selects an input from the input terminal SD to receive a test pattern. Respective bits of the test pattern are sequentially shifted to the scan F/Fs, and the scan F/Fs connected in a serial chain receive the respective bits of the test pattern. Because of the control signal ST1=1, the clock CLK2 is always at high level, and the clocked inverter 93 in FIG. 14 is always open. The bypass F/F 20 is in a state where it so operates as to always bypass a signal at the input terminal D to the output terminal Q.

At time t2 when all the scan F/Fs 30-1 and 30-2 store the test pattern, the scan F/Fs 30-1 and 30-2 shift to the normal operation mode. Data is input from the input pin of the semiconductor integrated circuit 10. The combinational logic circuit 60-1 executes logic operation based on the input data. The input signal of the bypass F/F 20 is bypassed to an output terminal. That is, the bypass F/F 20 functions as merely a signal line or buffer. The logic operation result of the combinational logic circuit 60-1 is input to the combinational logic circuit 60-2. The combinational logic circuit 60-2 performs logic operation based on the operation result of the combinational logic circuit 60-1. The scan F/F 30-2 in the normal operation mode is in a state where it receives an input signal from the input terminal D. The operation result of the combinational logic circuit 60-2 is input to the scan F/F 30-2.

At time t3, the scan F/Fs 30-1 and 30-2 shift to shift operation again. This shift operation extracts the operation results of the combinational logic circuits 60-1 and 60-2 from the output pin.

At time t4, the bypass F/F 20 and the scan F/Fs 30-1 and 30-2 shift to the normal operation mode.

As described above, in the semiconductor device according to the third embodiment, whether to bypass the input D to the output Q in the bypass F/F is determined depending on the clock CLK2. In other words, the clock generator 100 which generates the clock CLK2 functions as a means for bypassing the input D and output Q in the bypass F/F. In addition to the effects described in the first embodiment, the third embodiment can reduce the wiring amount and further suppress an increase in circuit area. This is because the control signal ST1 suffices to be supplied to only the clock generator 100, and the first signal line 40 suffices to be connected to the clock generator 100. Unlike the first and second embodiments, the first signal line 40 need not be connected to all bypass F/Fs.

The third embodiment can be combined with the first embodiment. More specifically, the scan F/F may adopt the arrangement shown in FIG. 4A or 4B, and the bypass F/F may employ the arrangement shown in FIG. 14.

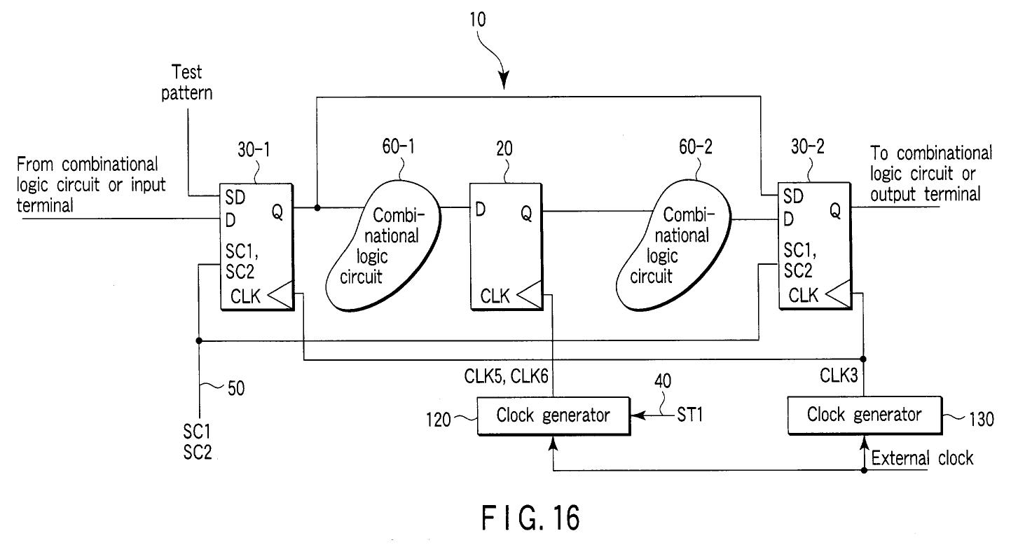

A semiconductor device according to the fourth embodiment of the present invention will be described with reference to FIG. 16. FIG. 16 is a block diagram showing a semiconductor integrated circuit. The semiconductor integrated circuit according to this embodiment also comprises many F/Fs and combinational logic circuits, as described in the first embodiment with reference to FIG. 2. For descriptive convenience, a simplified circuit arrangement is shown. Similar to the third embodiment, the fourth embodiment controls by a clock whether to bypass the input D and output Q in the bypass F/F.

As shown in FIG. 16, an LSI 10 has a bypass F/F 20, scan F/Fs 30-1 and 30-2, a first signal line 40, a second signal line 50, combinational logic circuits 60-1 and 60-2, and clock generators (switching circuits) 120 and 130.

The clock generator 130 generates a clock CLK3 on the basis of an external clock. The clock generator 120 generates clocks CLK5 and CLK6 on the basis of the external clock and the control signal ST1 which propagates through the first signal line 40. While the control signal ST1 is “1”, the clock generator 120 adjusts the clocks CLK5 and CLK6 in phase.

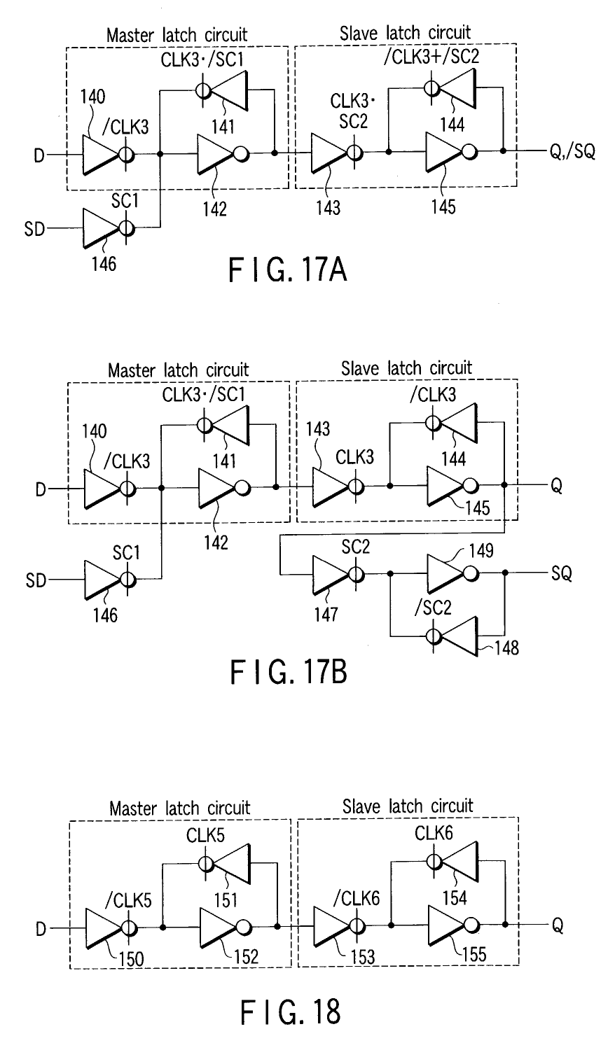

The arrangement of the scan F/Fs 30-1 and 30-2 will be explained with reference to FIGS. 17A and 17B. FIG. 17A is a circuit diagram showing the arrangement of the scan F/Fs 30-1 and 30-2. FIG. 17B is a circuit diagram showing another arrangement of the scan F/Fs 30-1 and 30-2.

As shown in FIGS. 17A and 17B, the scan F/Fs 30-1 and 30-2 according to the fourth embodiment are formed by replacing the clock CLK in the arrangement shown in FIGS. 4A and 4B with the clock CLK3.

The arrangement of the bypass F/F will be described with reference to FIG. 18. FIG. 18 is a circuit diagram showing the bypass F/F. As shown in FIG. 18, the bypass F/F 20 has a master latch circuit and slave latch circuit.

The master latch circuit has clocked inverters 150 and 151 and an inverter 152. The clocked inverter 150 functions as a transfer gate, and is opened for a high-level inverted clock /CLK5 (clock CLK5=low). The clocked inverter 151 has an output terminal connected to the output terminal of the clocked inverter 150, and an input terminal connected to the output terminal of the inverter 152. The clocked inverter 151 is opened for a high-level clock CLK5. The inverter 152 has an input terminal connected to the output terminal of the clocked inverter 150, and an output terminal serving as the output terminal of the master latch circuit.

The slave latch circuit has almost the same arrangement as that of the master latch circuit. More specifically, the slave latch circuit has clocked inverters 153 and 154 and an inverter 155. The clocked inverter 153 functions as a transfer gate, and is opened for a high-level inverted clock /CLK6 (clock CLK6=low). The clocked inverter 154 has an output terminal connected to the output terminal of the clocked inverter 153, and an input terminal connected to the output terminal of the inverter 155. The clocked inverter 154 is opened for a high-level clock CLK6. The inverter 155 has an input terminal connected to the output terminal of the clocked inverter 153, and an output terminal serving as the output terminal of the slave latch circuit, i.e., the output terminal Q of the F/F.

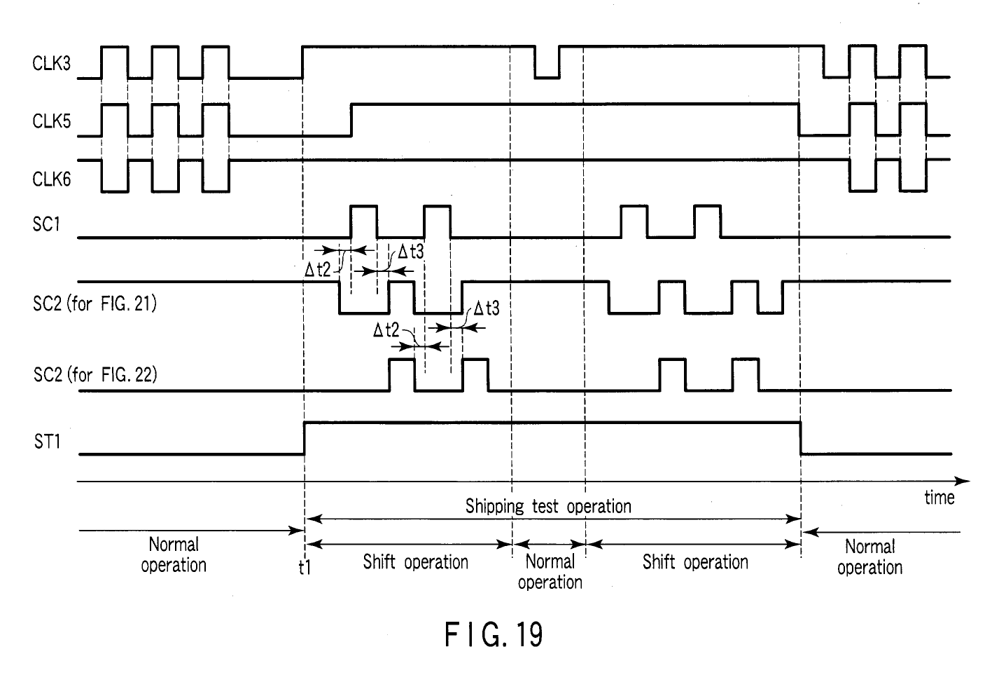

A semiconductor device scan test method according to the fourth embodiment will be described with reference to FIG. 19. FIG. 19 is a timing chart showing the clocks CLK3, CLK5, and CLK6, and control signals SC1, SC2, and ST1. For SC2, two timing patterns are shown for the arrangements of FIGS. 17A and 17B.

The relationship between the clocks CLK3, CLK5, and CLK6, and control signals SC1, SC2, and ST1 will be explained. The clock generator 130 generates a clock CLK3 on the basis of an external clock. The clock generator 120 generates clocks CLK5 and CLK6 on the basis of the external clock. The clock CLK5 has almost the same shape as that of the cock CLK3, and the clock CLK6 has a shape reversed from that of the clock CLK5. While the control signal ST1 is “1”, particularly in normal operation during shipping test operation, the clock generator 120 adjusts the clocks CLK5 and CLK6 in phase.

The control signals SC1 and SC2 have the following relationship in shift operation. The control signal SC2 rises Δt2 before the rise of the control signal SC1, and falls Δt3 after the fall of the control signal SC1. At short intervals before the rise of the control signal SC1 and immediately after its fall, both the control signals SC1 and SC2 is set to low level.

As shown in FIG. 19, a scan test starts at time t1. At the start of the scan test, the control signal ST1 input from an input pin is set to “1”. The bypass F/F 20 then shifts from the normal operation mode to the shipping test operation mode. The scan F/Fs 30-1 and 30-2 shift from the normal operation mode to the shift operation mode. The scan F/Fs 30-1 and 30-2 receive a test pattern in response to the control signals SC1 and SC2. Because of the control signal ST1=1, the clock CLK5=the clock CLK6. The clocked inverters 150 and 153 in FIG. 18 are opened at the same timing. The bypass F/F 20 is in a state where it so operates as to bypass a signal at the input terminal D to the output terminal Q.

After the test pattern is input, the scan F/Fs 30-1 and 30-2 sequentially shift from the normal operation mode to the shift operation mode. The operation results of the combinational logic circuits 60-1 and 60-2 are extracted from an output pin. Note that CLK5=CLK6 need not always be held during shipping test operation, and suffices to be met in normal operation during shipping test operation.

As described above, the semiconductor device according to the fourth embodiment can obtain the same effects as those described in the first and third embodiments. Further, the operation reliability of the semiconductor device can be improved, which will be explained below.

In a master-slave F/F, simultaneous opening of the transfer gates of the master and slave latch circuits should be avoided. That is, it is unpreferable to open a route from the input terminal D (or SD) to output terminal Q (or SQ) of the F/F. For example, in the arrangement shown in FIGS. 3 to 5B, the transfer gate 70 of the master latch circuit is opened for a high-level inverted clock /CLK, and the transfer gates 73, 82, and 84 of the slave latch circuit are opened for a high-level clock CLK. The inverted clock /CLK is a signal generated based on the clock CLK. These clocks CLK and /CLK rise and fall at the same timings. For a very short time at the clock edge, the transfer gates of the master and slave latch circuits may be opened. The clocked inverter 76 is opened for a high-level control signal SC1, and the clocked inverters 84 and 79 are opened for a high-level control signal SC2. When the control signals SC1 and SC2 perform similar operation to the clock CLK and /CLK, the same problem occurs.

Conversely, in the fourth embodiment, the control signal SC2 falls before the control signal SC1 rises, and rises after the control signal SC1 falls (see FIG. 19). At the instant when a clocked inverter 146 is closed, clocked inverters 143 and 147 are completely closed. After the clocked inverter 146 is closed, the clocked inverters 143 and 147 are opened. This can effectively suppress malfunction of the scan F/F.

This applies not only to the control signals SC1 and SC2 but also to the clocks CLK3, CLK5, and CLK6. The scan F/F is controlled not only by the clock CLK3 but also by two clocks, and the two clocks are given the same relationship as that between the control signals SC1 and SC2. The clocks CLK5 and CLK6 which control the bypass F/F are also given the same relationship as that between the control signals SC1 and SC2. At the instant when the transfer gate 150 of the master latch circuit is closed, the transfer gate 153 of the slave latch circuit is completely closed. After the transfer gate 150 is closed, the transfer gate 153 is opened. At the instant when the transfer gate 153 of the slave latch circuit is closed, the transfer gate 150 of the master latch circuit is completely closed. After the transfer gate 153 is closed, the transfer gate 150 is opened. That is, at the instant when the states of the master and slave latch circuits change, the transfer gates are always closed for a predetermined period. Malfunction of the bypass F/F and scan F/F can be more effectively suppressed.

As described above, in the semiconductor devices and their design methods according to the first to fourth embodiments of the present invention, some F/Fs are formed into bypass F/Fs during scan design of a semiconductor integrated circuit. The bypass F/F propagates an input signal at the input terminal D to the output terminal Q in accordance with the control signal ST1 in a shipping test. The number of additional circuits necessary for bypass design is smaller than the number of additional circuit necessary for scan path formation. An increase in circuit area along with scan design can therefore be suppressed. A small number of scan F/Fs reduces the input data amount in the test. As a result, the test process can be simplified, the memory amount required for a test circuit can be decreased, and the test cost can be reduced. As described in the first embodiment, the main purpose of increasing the number of F/Fs to simplify a combinational logic circuit is to increase the operation speed of a semiconductor integrated circuit. Even if some F/Fs are formed into bypass F/Fs without forming all F/Fs into scan F/Fs, this does not influence test operation and decrease the fault coverage.

As described in the second embodiment, the presence/absence of an asynchronous loop can be confirmed by the ATPG, and whether to form a scan or bypass F/F can be determined based on the result. Generation of a combinational logic circuit having a loop can be prevented, and the operation reliability of the semiconductor integrated circuit can be improved.

As described in the third and fourth embodiments, an F/F can be formed into a bypass F/F by changing the clock which controls F/F operation between the normal operation mode and the shipping test mode. In this case, as described above, the numbers of additional circuits and wiring lines necessary for bypass design become very small, and an increase in circuit area can be further suppressed.

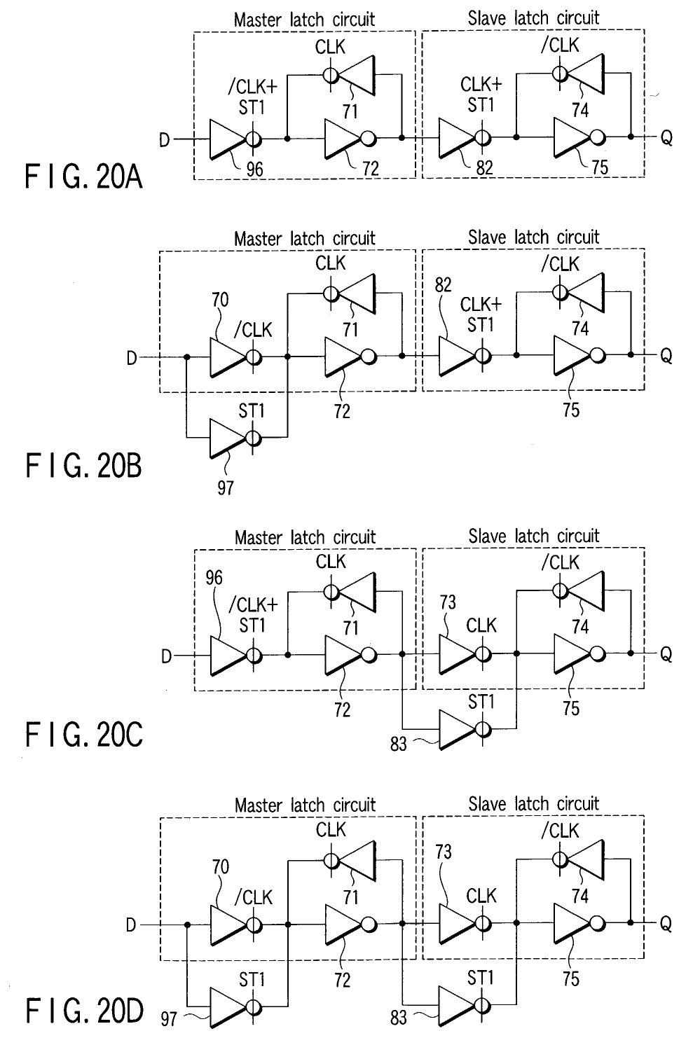

FIGS. 20A to 20D are circuit diagrams showing bypass F/Fs according to the first to fourth modifications to the first embodiment. In the example shown in FIG. 20A, the clocked inverter 70 in the arrangement shown in FIG. 5A is replaced with a clocked inverter 96. The clocked inverter 96 operates in response to the AND signal between the inverted clock /CLK and the control signal ST1, and is unconditionally opened for the control signal ST1=1.

In the example shown in FIG. 20B, a clocked inverter 97 is added to the arrangement shown in FIG. 5A. The clocked inverter 97 has an input terminal connected to the input terminal of the clocked inverter 70, and an output terminal connected to the output terminal of the clocked inverter 70. The clocked inverter 97 operates in response to the control signal ST1, and is opened for the control signal ST1=1.

In the example shown in FIG. 20C, the clocked inverter 70 in the arrangement shown in FIG. 5B is replaced with the clocked inverter 96. In the example shown in FIG. 20D, the clocked inverter 97 is added to the arrangement shown in FIG. 5B.

With the arrangements shown in FIGS. 20A to 20D, the bypass F/F in the shipping test operation mode bypasses a signal input to the input terminal D to the output terminal Q even for the clock CLK=low.

The above embodiments have exemplified a case in which the master latch circuit receives data for a low-level clock CLK and the slave latch circuit receives data for a high-level clock CLK. The embodiments can be applied to the opposite case. The above embodiments can be applied to general semiconductor integrated circuits subjected to scan design, and to, e.g., a memory-embedded system LSI. The embodiments of the present invention exhibit an enhanced effect for a semiconductor integrated circuit having a larger number of stages, and are effective in, e.g., a semiconductor integrated circuit for an image processing system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device having first and second operation modes, comprising:
a signal line which transmits an instruction signal in the second operation mode;
a first flip-flop which operates in synchronism with a clock in the first operation mode and the instruction signal in the second operation mode;
a switching circuit which propagates an input to an output of the first flip-flop in response to the instruction signal in the second operation mode; and
a second flip-flop which operates in synchronism with the clock in the first operation mode, and in the second operation mode, selects a test pattern as an input signal instead of an input signal in the first operation mode, and operates in synchronism with the clock.

2. The device according to claim 1, wherein
the first and second flip-flops have the same arrangement,
the switching circuit controls the clock in response to the instruction signal in the second operation mode, and
the first flip-flop is controlled to a state in which the first flip-flop operates in synchronism with the clock controlled by the switching circuit in the second operation mode to directly connect the input to the output.

3. The device according to claim 1, further comprising a third flip-flop which operates in synchronism with a clock in the first operation mode,
wherein the switching circuit propagates inputs to outputs of the first and third flip-flops in response to the instruction signal in the second operation mode.

4. The device according to claim 3, wherein
the first to third flip-flops have the same arrangement,
the switching circuit controls the clock in response to the instruction signal in the second operation mode, and
the first and third flip-flops are controlled to a state in which the first and third flip-flops operate in synchronism with the clock controlled by the switching circuit in the second operation mode to directly connect the inputs to the outputs.

5. The device according to claim 1, further comprising a combinational logic circuit interposed between the first and second flip-flops,
wherein the second flip-flop inputs the test pattern to the combinational logic circuit in the second operation mode,
the combinational logic circuit performs logic operation based on the test pattern, and
the first flip-flop outputs a logic operation result obtained by the combinational logic circuit in response to the instruction signal.

6. The device according to claim 1, wherein the switching circuit is part of the first flip-flop.

7. The device according to claim 1, wherein
the first flip-flop is of a master-slave type including a master latch circuit and a slave latch circuit, and
the switching circuit includes an inverter which is parallel-connected to a transfer gate of the slave latch circuit and operates in the second operation mode in response to the instruction signal in opposite phase to the clock which controls operation of the transfer gate of the slave latch circuit.

8. The device according to claim 1, wherein
the first flip-flop is of a master-slave type including a master latch circuit and a slave latch circuit, and
the switching circuit adjusts clocks input to the master latch circuit and the slave latch circuit to be in phase in the second operation mode.

9. The device according to claim 1, wherein
the first flip-flop includes a transfer gate connected to an input terminal, and a latch circuit connected to an output stage of the transfer gate, and
the switching circuit fixes the clock which controls operation of the transfer gate of the first flip-flop to a predetermined level in the second operation mode.

10. A semiconductor device having first and second operation modes, comprising:
a first semiconductor circuit which operates as a sequential logic circuit in the first operation mode and a combinational logic circuit in the second operation mode;
a first flip-flop which is arranged in the first semiconductor circuit;
a switching circuit which propagates an input to an output of the first flip-flop in response to an instruction signal input in the second operation mode, and propagates the input to the output in the first flip-flop in synchronism with a clock in the first operation mode, thereby switching operation of the first semiconductor circuit between the sequential logic circuit and the combinational logic circuit; and
a second flip-flop which operates in synchronism with the clock in the first operation mode, and in the second operation mode, selects a test pattern as an input signal instead of an input signal in the first operation mode, and inputs the test pattern to the first semiconductor circuit in synchronism with the clock.

11. The device according to claim 10, wherein
the first and second flip-flops have the same arrangement,
the switching circuit controls the clock in response to the instruction signal in the second operation mode, and
the first semiconductor circuit switches the operation from the sequential logic circuit to the combinational logic circuit by operating the first flip-flop in synchronism with the clock controlled by the switching circuit in the second operation mode.

12. The device according to claim 10, further comprising:
a second semiconductor circuit which operates as a sequential logic circuit in the first operation mode and a combinational logic circuit in the second operation mode; and
a third flip-flop which is arranged in the second semiconductor circuit,
wherein the switching circuit switches the operations of the first and second semiconductor circuits by controlling operations of the first and third flip-flops.

13. The device according to claim 10, wherein
the second flip-flop inputs the test pattern to the first semiconductor circuit in the second operation mode, and
the first semiconductor circuit performs logic operation based on the test pattern stored in the second flip-flop.

14. The device according to claim 10, wherein the switching circuit is part of the first flip-flop.

15. The device according to claim 10, wherein
the first flip-flop is of a master-slave type including a master latch circuit and a slave latch circuit, and
the switching circuit includes an inverter which is parallel-connected to a transfer gate of the slave latch circuit and operates in the second operation mode in response to the instruction signal in opposite phase to the clock which controls operation of the transfer gate of the slave latch circuit.

16. The device according to claim 10, wherein
the first flip-flop is of a master-slave type including a master latch circuit and a slave latch circuit, and
the switching circuit adjusts clocks input to the master latch circuit and the slave latch circuit to be in phase in the second operation mode.

17. The device according to claim 10, wherein
the first flip-flop includes a transfer gate connected to an input terminal, and a latch circuit connected to an output stage of the transfer gate, and
the switching circuit fixes the clock which controls operation of the transfer gate of the first flip-flop to a predetermined level in the second operation mode.

18. A semiconductor device design method comprising:
designing a semiconductor integrated circuit while forming all flip-flops into bypass flip-flops;
performing an operation test of the semiconductor integrated circuit to determine whether a loop circuit incorporating the flip-flop exists; and
when the loop circuit is determined to exist, forming at least the flip-flop incorporated in the loop circuit into a scan flip-flop to change the loop circuit into a sequential logic circuit.

19. The method according to claim 18, wherein forming flip-flops into the bypass flip-flops includes giving the flip-flops a first operation mode in which the flip-flops operate in synchronism with a clock and a second operation mode in which an input is propagated to an output in response to an instruction signal input in the test.
